(19) United States
(12) Patent Application Publication
(10) Pub. No.: US 2019/0002087 A1
(43) Pub. Date: Jan. 3, 2019

(54) AUTOMATED AIRCRAFT FUEL MANAGEMENT AND TRANSFER SYSTEM

(71) Applicant: XP Services, Inc., Tullahoma, TN (US)

(72) Inventors: Carey Mills, Meridianville, AL (US); James Wright, Owens Cross Roads, AL (US)

(21) Appl. No.: 16/019,640

(22) Filed: Jun. 27, 2018

Related U.S. Application Data
(60) Provisional application No. 62/526,390, filed on Jun. 29, 2017.

(51) Int. Cl. B64C 17/10; B64D 37/04

(52) U.S. Cl. CPC B64C 17/10; B64D 37/04

(57) ABSTRACT

A fuel distribution system for an aircraft having wing and fuselage fuel tanks. The system includes sensors for indicating the level of fuel in each tank and at least one selectively controllable pump for moving fuel between the fuselage tank and one or more wing tanks. A controller is configured to monitor sensed fuel levels in the wing and fuselage tanks and selectively control the pump to shift fuel between the fuselage tank and the one or more wing tanks to maintain the aircraft's longitudinal center of gravity within preselected limits.

### RELATED APPLICATIONS

This application claims priority to U.S. Provisional Patent Application No. 62/526,390, filed Jun. 29, 2017, and incorporates the same herein by reference.

### TECHNICAL FIELD

This invention relates to a system for automatic, real time monitoring, managing, and transferring fuel levels between wing and fuselage tanks in an aircraft, as required. More particularly, by managing and balancing fuel levels, the invention enhances safety by eliminating unnecessary center of gravity excursions, and enhancing aircraft handling qualities.

### BACKGROUND

Most conventional single engine aircraft have fuel tanks in the wings. Generally, these wing tanks drain by gravity to a centrally located collector (e.g. header or belly tank) from which fuel is pumped to the engine. Side-to-side balance of fuel is generally self-maintaining, unless flight angle or maneuvering causes a temporary or extended unbalance. In any event, a minor side-to-side center of gravity (CG) imbalance is easily compensated for and does not normally create a hazardous condition.

Some single engine aircraft adapted for special uses also have a fuselage (center) fuel tank located forward of, aft of, or under the cockpit. In these designs, the wing tanks will typically be aft and the center tank forward of the center for gravity, but configurations may vary. The original typical design of these aircraft was often for carrying a liquid payload in the center tank, such as for agricultural spraying. Adapted models use this capacity to carry additional fuel so the aircraft range and endurance can be extended. As originally designed, the operator would have to monitor fuel level gauges and manually select the applicable fuel tank that supplies fuel flow from the wing and center tanks every few minutes to maintain appropriate fuel levels and control weight distribution for maintaining a relatively constant CG, particularly fore-to-aft CG, because these conventional fuel systems are incapable of rebalancing themselves once an imbalance is introduced.

One example is the Turbo Thrush, Model S2R-T660 aircraft variants, made by Thrush Aircraft Inc. of Albany, Ga. One variant has been adapted by IOMAX USA, Inc. of Mooresville, N.C., to the Archangel Border Patrol Aircraft. The Archangel is a multi-mission platform adapted, for example, for intelligence, surveillance, and reconnaissance (ISR), and capable of performing long duration military or civil security operations.

### SUMMARY

The present invention provides a fuel distribution system for an aircraft having wing and fuselage fuel tanks. The system includes sensors for indicating the level of fuel in each tank and at least one selectively controllable pump for moving fuel between the fuselage tank and one or more wing tanks. A controller is configured to monitor sensed fuel levels in the wing and fuselage tanks and selectively control the pump to shift fuel between the fuselage tank and the one or more wing tanks to maintain the aircraft's longitudinal center of gravity within preselected limits.

The automatic fuel management and transfer system (“AFMS” or “AFMTS”) works by way of a fuel management controller that automates the monitoring and control of fuel balance between fuel tanks. The AFMTS uses software logic, an aerospace motor controller, and electro-mechanical fuel pumps to maintain a balance between the aircraft's wing fuel tank system and center (fuselage) fuel tank to maintain a safe, relatively consistent center of gravity (CG) position in both the aircraft's longitudinal and lateral axes, assuming the aircrew properly loads and configures the aircraft prior to takeoff. Automation of this monitoring and control enhances flight safety, reduces pilot workload, allows the crew to focus on their mission critical tasks, and optimizes aircraft operations by monitoring and controlling fuel levels to maintain a balance between the aircraft's wing fuel tank system and center fuel tank system in a usable and safe range.

Other aspects, features, benefits, and advantages of the present invention will become apparent to a person of skill in the art from the detailed description of various embodiments with reference to the accompanying drawing figures, all of which comprise part of the disclosure.

### BRIEF DESCRIPTION OF THE DRAWINGS

Like reference numerals are used to indicate like parts or items throughout the various drawing figures, wherein:

FIG. 1 is a side view of a representative aircraft on which the present invention could be installed or used;

FIG. 2 is a schematic diagram of a fuel management system according to one embodiment of the present invention;

FIG. 3 is a graph showing a representative fuel burn profile according to one embodiment of the present invention;

FIG. 4 is a graph showing a center of gravity ratio between load in center and wing fuel tanks;

FIG. 5 shows a user interface according to one embodiment of the invention;

FIG. 6 is a chart of system switch logic according to one embodiment of the invention;

FIG. 7 is a schematic diagram of a fuel management system according to another embodiment of the present invention; and

FIG. 8 is chart of system switch logic according to another embodiment of the invention.

### DETAILED DESCRIPTION

With reference to the drawing figures, this section describes particular embodiments and their detailed construction and operation. Throughout the specification, reference to “one embodiment,” “an embodiment,” or “some embodiments” means that a particular described feature, structure, or characteristic may be included in at least one embodiment. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

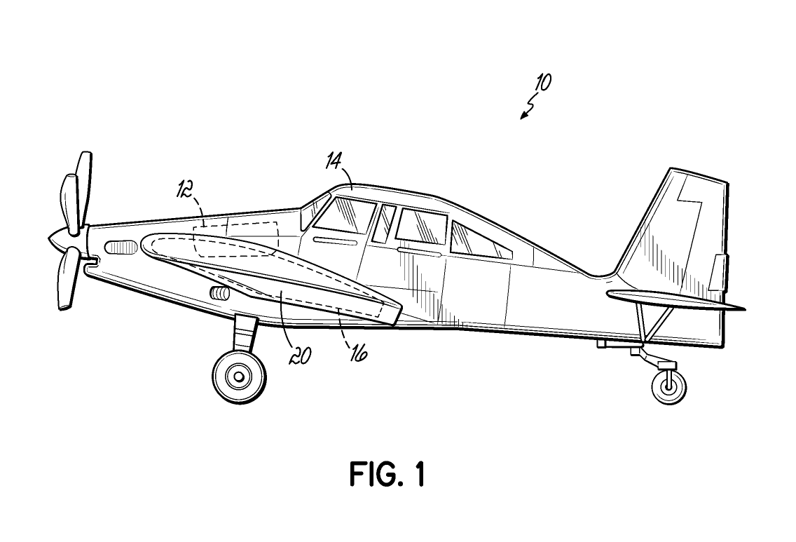

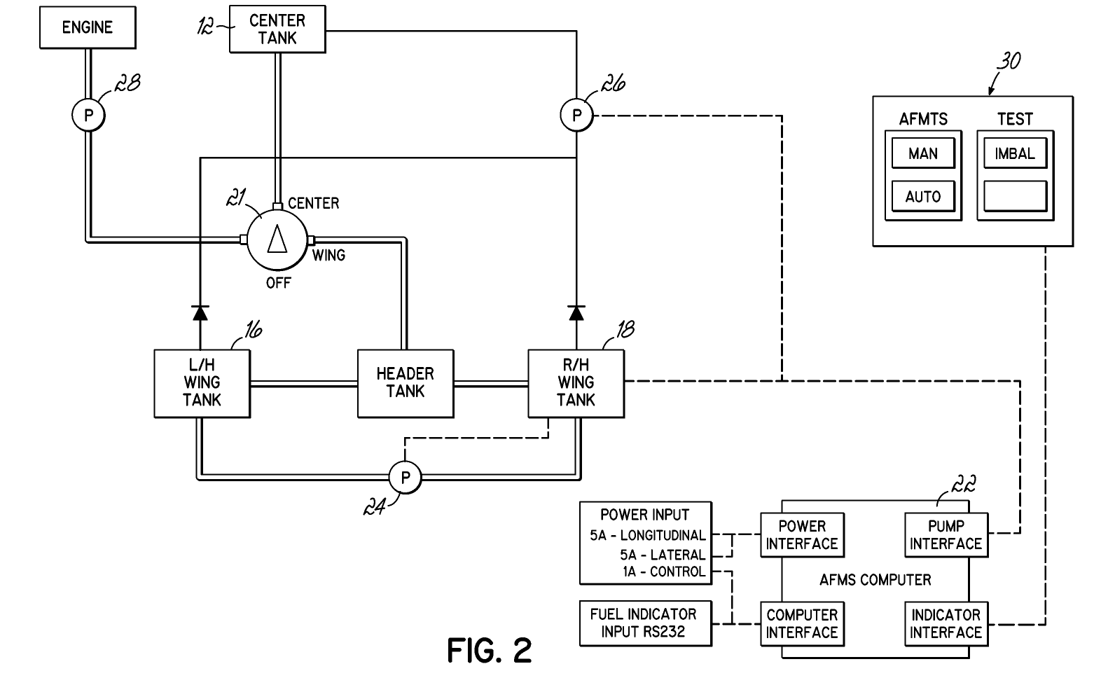

The AFMTS provides an aerospace motor controller with aircraft specific firmware designed to automate the monitoring and fuel balance on a multi-tank aircraft having fuel tanks both in the wings and in the fuselage. For example, referring to FIG. 1, the IOMAX Archangel Border Patrol Aircraft 10 includes a center fuel tank (illustrated schematically at 12) positioned forward of the cockpit 14. Left and right wing fuel tanks (illustrated schematically at 16 and 18) may include multiple chambers in each wing 20. The center tank 12, sometimes referred to as the hopper, may hold 660 U.S. gallons and the wing tanks 228 U.S. gallons of fuel in the S2R-T660. As originally designed, balance of fuel between these tanks 12, 14, 16 would be manually monitored and controlled by an OEM fuel selector lever 21. Referring now also to FIG. 2, the AFMTS uses software logic and electro-mechanical fuel pumps 24, 26, 28 to maintain a balance between the aircraft's wing fuel tank system 16, 18 and center (fuselage) fuel tank 12 to maintain a safe center-of-gravity (CG) position in the aircraft's longitudinal axis. The nominal aircraft configuration for which the example AFMTS is designed is the “baseline configuration,” which consists of the basic aircraft, electro-optical sensor/intelligence surveillance reconnaissance (EOS/ISR) pod (Sta. 4), weapon pylons on the wing stations (Sta. 1-3/5-7), two crewmembers, and full fuel.

The AFMTS can use existing fuel quantity indications as reported by the OEM sensors (such as the Electronics International, Inc. MVP-50T Engine Analyzer and Systems Monitor) to determine when, where, and how much fuel to transfer to optimize the aircraft CG limits. Fuel transfer is based on current fuel loading (quantity and location) and current fuel burn rate. The pilot has the option to operate the aircraft with the AFMTS in the AUTO (automatic) mode or to select MAN (manual) mode of fuel management, where the pilot controls fuel source and quantity balance using the original equipment manufacturer aircraft fuel selector.

The AFMTS fuel management logic considers the basic empty weight of the aircraft, its empty weight CG, its fully loaded/manned weight and CG, and minimum reserve fuel level. In the example embodiment, the fuel management logic is based on a production Archangel aircraft with a basic empty weight of approximately 8,170 pounds and a longitudinal CG no greater than 27.0 inches aft of datum. Allowing for full fuel, a crew of two pilots at 205 pounds each, the Archangel standard EOS/ISR pod installed on the aircraft centerline, and 6 empty weapon/store pylons installed on the six wing stations, this weight and balance condition is defined as the design mission gross weight (DMGW). At DMGW, the aircraft's takeoff weight and balance condition is 13,862 pounds with a longitudinal CG at 24.94 inches aft of datum. In AUTO mode, the AFMTS is designed to manage the longitudinal fuel balance by transferring fuel as required, depleting both the center fuel tank and the wing tanks at an optimum rate to maintain a CG within safe limits as the fuel burns down to the minimum fuel reserved level of 50 gallons in the center tank (wing tanks empty).

The aerospace motor controller may include a digitally controlled motor controller with application-specific firmware authored to facilitate the Automatic Fuel Management and Transfer operations. Additionally, the aerospace motor controller may include a digital electrical surge stopping function to provide a greater level of system protection than circuit breakers only. The surge stopping components may be integral to the aerospace motor controller, or housed in a separate external unit. The computer 22 monitors internal system faults, digital input faults, and motor control faults to ensure reliable operations. The aerospace motor controller performs two major actions: it monitors fuel level relationships and it controls the fuel pumps 24, 26 to transfer fuel as required to maintain a safe longitudinal axis CG. While in operation, the system will monitor its own computer and motor control operations to ensure system integrity, monitor digital data input to ensure valid data, monitor fuel levels to alert the pilot of an imbalanced fuel load, control (when enabled) the fuel pumps 24, 26 to maintain nominal fuel loads, and output state information to pilot indicators and the system. The aerospace motor controller can be tested at any time by the pilot using the AFMTS Status annunciator push-button switch.

The fuel pumps 24, 26 may be, for example, the Weldon Aerospace 18009-B8 fuel pump. It is a certified primary/boost/transfer pump with a rated flow range of 118 gallons per hour (GPH) of fuel, at 12.5 pounds per square inch, gage (PSIG), 28 volts DC at 4 amps. The pump may be used with any primary or alternate fuel authorized for use in the Archangel's Pratt & Whitney PT6A-67F engine. This pump utilizes a permanent magnet motor, is a self-priming, high suction lift pump with integral pressure relief valve and built-in bypass. The pump temperature range is −65 F.° to 185 F°, and weighs 2.7 pounds total.

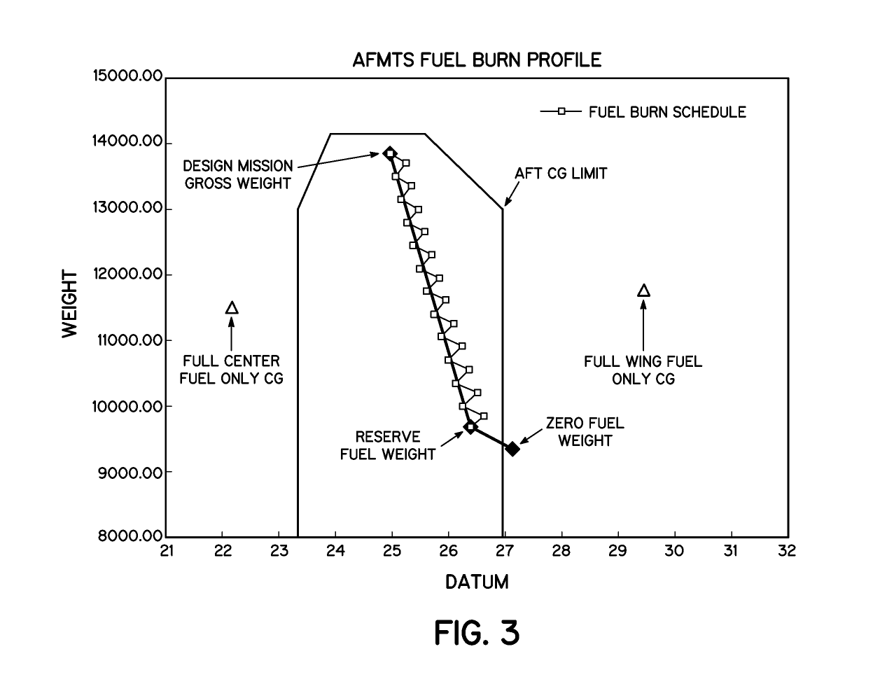

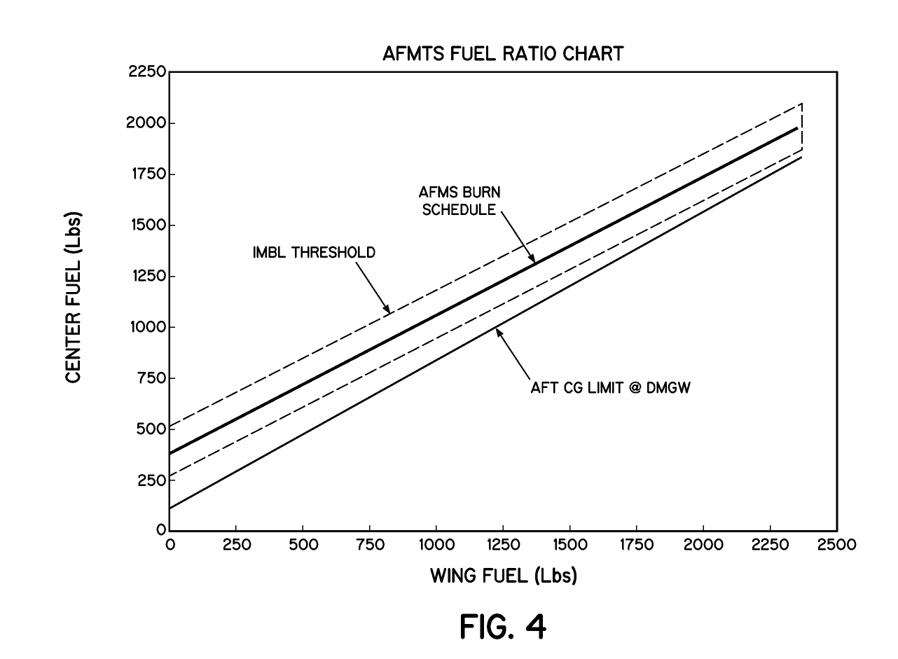

An exemplary automatic fuel management system burn profile is shown in FIG. 3. An exemplary AFMTS fuel ration chart is shown in FIG. 4. Together, these two graphs illustrate how the control processor 22 can be programmed to monitor fuel levels and operate respective pumps 24, 26 to draw or redistribute fuel between tanks 12, 16, 18 so that the longitudinal (and lateral) CG is optimized within defined acceptable limits. Because the fuel tanks 12, 16, 18 may be irregular in shape, the level sensed in each tank must be translated to reflect its corresponding volume/weight.

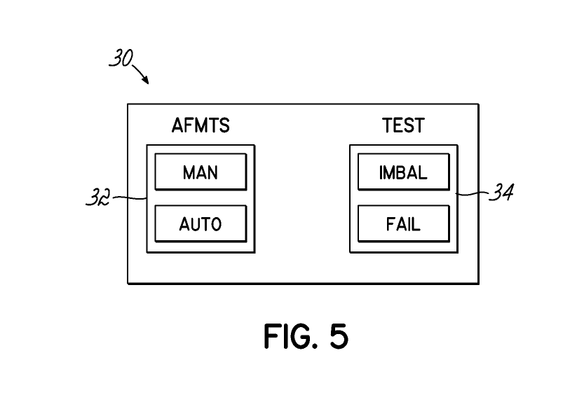

As shown in FIG. 5, the interface 30 between the pilot and AFMTS can be very simple. For example, there can be two push-button switch controls 32, 34 in the AFMTS, such as the Vivisun® lighted pushbutton switches made by Applied Avionics, Inc. of Fort Worth, Tex. One switch 32, positioned on the aircraft fuel selector panel allows the pilot to select the AFMTS to AUTO or MAN with positive push-on/push-off function. The other switch 34, located on the aircraft annunciator panel, can be a momentary push-button switch that allows the pilot to acknowledge caution annunciations for a fuel imbalance (IMBAL), an AFMTS communication break with the fuel transfer pump (FAIL), or other built-in test (BIT) failures described below. The operational indications of these two switches and the failure modes are described in more detail below.

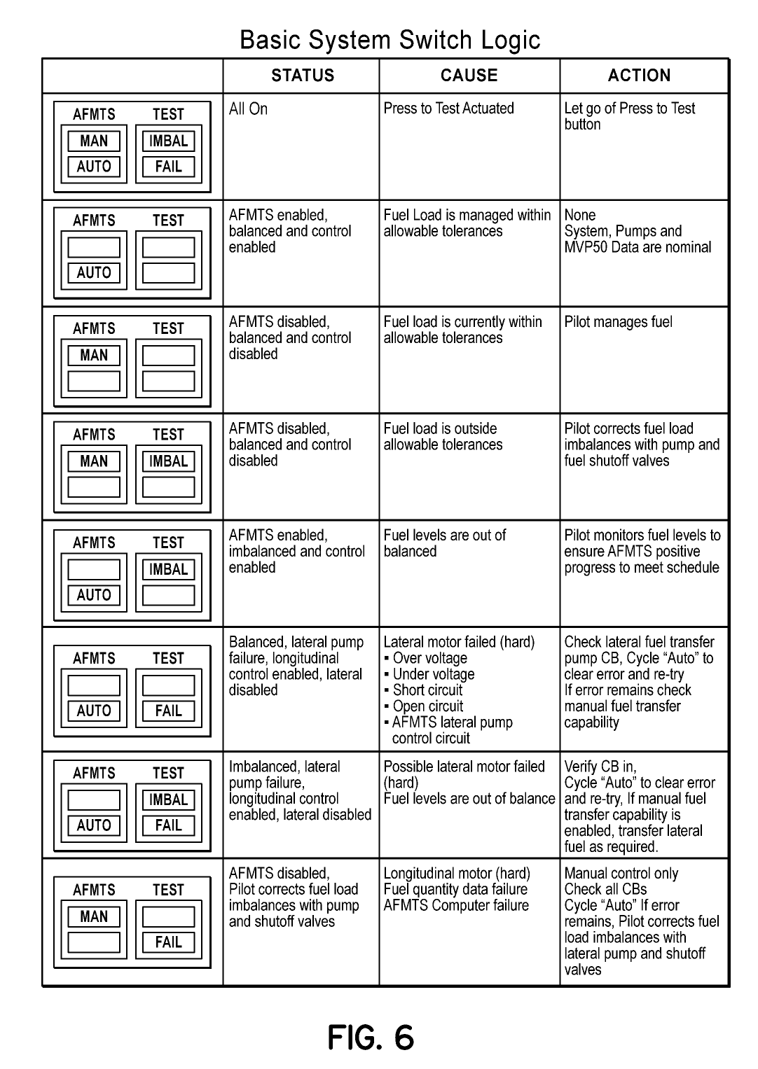

Referring now to the table of FIG. 6, the AFMTS provides notification to the pilot when a system failure occurs. If a FAIL indication illuminates on the AFMTS Status switch 34 on the aircraft annunciator panel 30, it notifies the pilot that the AFMTS is no longer communicating with a transfer pump 24, 26, and thus is no longer capable of performing automated fuel transfer and CG management tasks within design limits. This FAIL indication may be illuminated by any one (or more) of six component failures or out-of-range conditions: (1) a transfer pump has experienced an under-voltage condition, (2) a transfer pump has experienced an over-voltage condition, (3) a transfer pump has experienced an open circuit condition, (4) a transfer pump has experienced a short circuit condition, (5) the AFMTS control circuit or digital data stream has failed, and/or (6) electrical current output to a transfer pump is inconsistent with the commanded state. Unless there is a back-up system for these faults, pilot action will be required to manage the fuel quantities manually for safe CG maintenance the remainder of the flight by using the OEM fuel selector lever 21. Cautions, warnings, and operating limits published in the manufacturer's Flight Operations Manual for CG control remain in full effect.

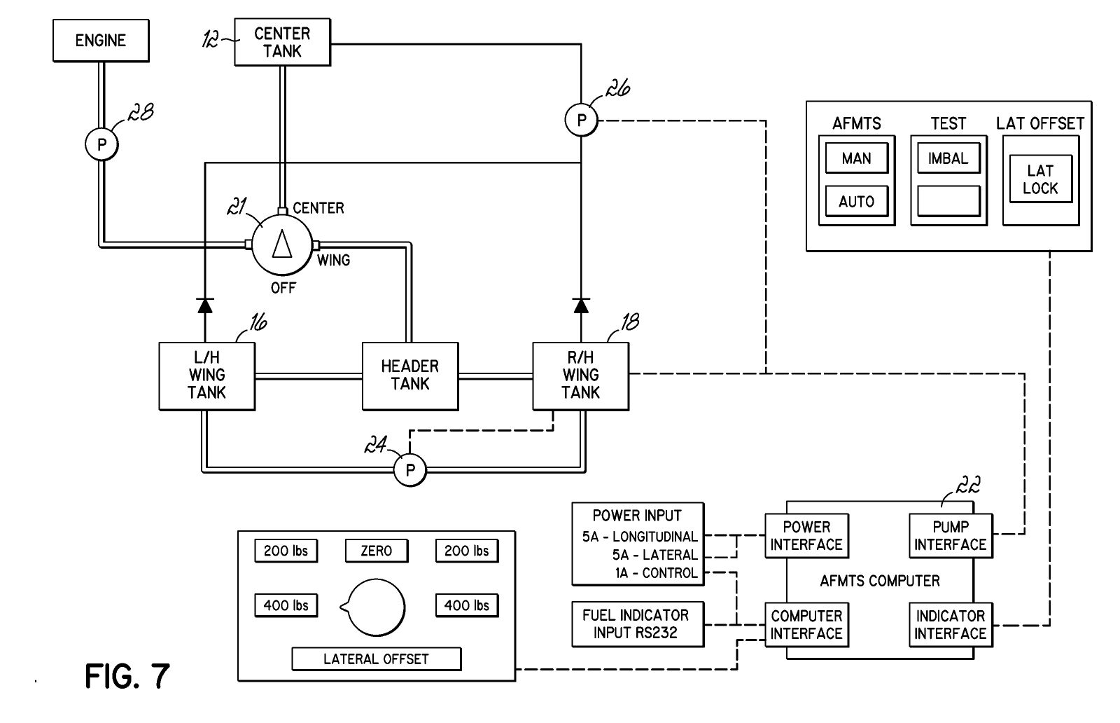

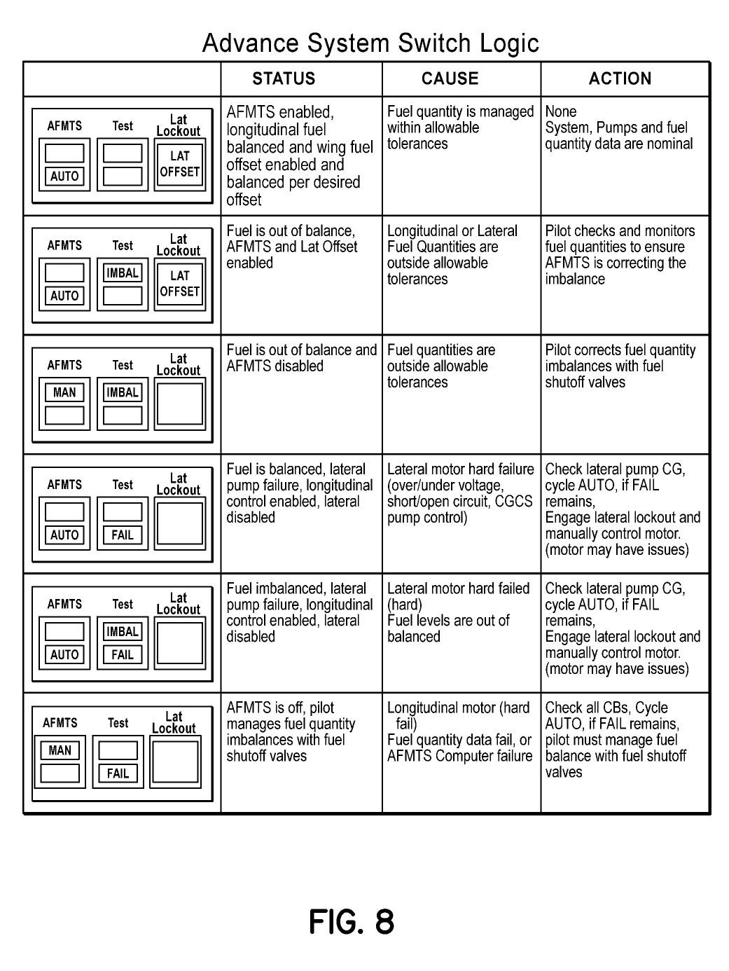

Advanced features may be added to or included in the AFMTS. The AFMTS architecture provides modular growth options. These options include the introduction of a lateral CG balance capability, lateral CG offset, programmable starting CG options (various configurations and/or lateral bias), gauge verification by mutual agreement, excessive fuel seepage/leaks due to malfunctioning tank vents, drain valves, or fuel cell battle damage. Examples of additional capability and displays are shown in FIGS. 7 and 8. Management of lateral fuel CG may also integrate with the Weapons Controller, if the aircraft 10 is so equipped, to compensate for change in weight distribution before/after a wing-mounted weapon system (not shown) has been deployed.

While one or more embodiments of the present invention have been described in detail, it should be apparent that modifications and variations thereto are possible, all of which fall within the true spirit and scope of the invention. Therefore, the foregoing is intended only to be illustrative of the principles of the invention. Further, since numerous modifications and changes will readily occur to those skilled in the art, it is not intended to limit the invention to the exact construction and operation shown and described. Accordingly, all suitable modifications and equivalents may be included and considered to fall within the scope of the invention, defined by the following claim or claims.

What is claimed is:

1. A fuel distribution system for an aircraft having wing and fuselage fuel tanks, the system comprising:
sensors for indicating the level of fuel in each tank;
at least one selectively controllable pump for moving fuel between the fuselage tank and one or more wing tanks; and
a controller configured to monitor sensed fuel levels in the wing and fuselage tanks and selectively control the pump to shift fuel between the fuselage tank and the one or more wing tanks to maintain the aircraft's longitudinal center of gravity within preselected limits.

2. The system of claim 1, further comprising a second selectively controllable pump for moving fuel between left and right wing tanks and the controller being configured to also control the second pump to shift fuel between the wing tanks to maintain the aircraft's lateral center of gravity within preselected limits.

3. The system of claim 1, further comprising an indicator and the controller being configured to signal a fuel imbalance condition.

4. The system of claim 1, further comprising an indicator and the controller being configured to signal at least one of the following component failures or out-of-range conditions: (1) a pump has experienced an under-voltage condition, (2) a pump has experienced an over-voltage condition, (3) a pump has experienced an open circuit condition, (4) a pump has experienced a short circuit condition, (5) a controller circuit or sensor signal has failed, and/or (6) electrical current output to a pump is inconsistent with the commanded state.

5. The system of claim 1, wherein the fuselage tank is located forward of a pilot cockpit.

6. A method of distributing fuel in an aircraft having one or more wing and fuselage fuel tanks, comprising:
receiving first signals at a controller indicative of the level of fuel in each tank;
determining an amount of fuel to move between the one or more wing tanks and the fuselage tank to maintain the aircraft's longitudinal center of gravity within preselected limits by the controller based at least in part on the first signals; and
transmitting a second signal from the controller to a pump to move the determined amount of fuel between the fuselage tank and the one or more wing tanks.

7. The method of claim 6, wherein the fuselage tank is located forward of a pilot cockpit.

8. The method of claim 6, further comprising determining an amount of fuel to move between left and right wing tanks and the controller transmitting another signal a second pump to move fuel between the wing tanks to maintain the aircraft's lateral center of gravity within preselected limits.

9. The method of claim 6, further comprising providing an indicator and configuring the controller to indicate a fuel imbalance condition.

10. The method of claim 6, further comprising providing an indicator and configuring the controller to indicate at least one of the following component failures or out-of-range conditions: (1) a pump has experienced an under-voltage condition, (2) a pump has experienced an over-voltage condition, (3) a pump has experienced an open circuit condition, (4) a pump has experienced a short circuit condition, (5) a controller circuit or sensor signal has failed, and/or (6) electrical current output to a pump is inconsistent with the commanded state.
